(19) United States
(12) Patent Application Publication
(10) Pub. No.: US 2016/0230458 A1
(43) Pub. Date: Aug. 11, 2016

(54) SLIDING ANTI-INSECT WINDOW CONSTRUCTING STRUCTURE HAVING SEGMENTED DETACHABLE RAIL FRAMES

(71) Applicant: FILOBE CO., LTD., Daegu (KR)

(72) Inventor: Kwang-Seok LEE, Daegu (KR)

(73) Assignee: Filobe Co., Ltd., Daegu (KR)

(21) Appl. No.: 15/022,162

(22) PCT Filed: Sep. 17, 2014
(86) PCT No.: PCT/KR2014/008672

§ 371 Date: Mar. 15, 2016

(30) Foreign Application Priority Data
Sep. 17, 2013 (KR) 10-2013-0112143

(51) Int. Cl. E06B 9/52; E06B 3/54; E06B 3/263

(52) U.S. Cl. CPC E06B 9/52; E06B 3/26347; E06B 3/5454; E06B 2003/5463

(57) ABSTRACT

The present invention relates to the installation structure of a rail frame for guiding a sliding movement of a roller apparatus of a sliding insect window screen which is capable of supporting a sliding insect window screen and providing a sliding opening/closing action of the sliding insect screen. more particularly relates to the sliding insect window screen comprising the rail frame which can more stably support the sliding insect window screen on the top surface and on the bottom surface, so even if a strong wind blows against the sliding insect screen, it is possible for the sliding insect window screen to maintain a stable state without shaking movement.

### TECHNICAL FIELD

The present invention relates to the installation structure of a rail frame for guiding a sliding movement of a roller apparatus of a sliding insect window screen which is capable of supporting a sliding insect window screen and providing a sliding opening/closing action of the sliding insect screen. More particularly, the present invention relates to the sliding insect window screen comprising the rail frame which can more stably support the sliding insect window screen on the top surface and on the bottom surface, so even if a strong wind blows against the sliding insect screen, it is possible for the sliding insect window screen to maintain a stable state without shaking movement.

Moreover, the present invention relates to the sliding insect window screen which is appropriate for being installed in front of a sliding window for constituting a special sliding window system. The special sliding window system has a glass panel which is directly and removably seated on and supported by rollers without a quadrilateral door sash that supports the glass panel forming the sliding window so as to minimize a phenomenon of reducing an open view through the sliding window. Also, the glass panel includes vertical stiffeners with an enlarged cross-section (cross-section having a thickness thicker than the glass panel) attached to the both side surfaces of the glass panel so as to reinforce transverse bending rigidity of the glass panel and to exhibit high wind pressure resistance. In this special sliding window system with the above-described structure, upper and lower pocket guides are respectively formed in upper and lower door guide frames used as a window frame member that guides a sliding movement of the sliding window so as to guide the upper end and lower end of the sliding window in both inner and outer surfaces of the sliding window, thereby supporting a smooth movement of the sliding window. In order to allow the sliding window provided with the vertical stiffeners to be integrally installed within a door guide frame, and to allow the sliding window to be separated from the door guide frame in a state where the sliding window is provided with the vertical stiffeners, a pocket guide is formed as pocket guide segments removable from a door guide frame body, and the pocket guide segments are successively installed to be separable from each other on both the inner and outer surfaces of the sliding window along the travel direction of the roller guide rail.

### BACKGROUND ART

The present invention relates to an insect window screen for installation on the outside of the windows in order to prevent indoor entry of various insects, and particularly the insect window screen of the mesh type with being coupled between a lower screen chassis and an upper screen chassis and sliding along the rail provided on the insect window screen installation frame equipped in front of the sliding window installation frame.

In general, there are two types of insect window screen. The one type is a fixed insect window screen which is fixed to the window installation frame by using hinge and screws. The other type is a moving insect window screen which is sliding along the rail on the insect window screen installation frame which is additionally constructed in front of window installation frame 10 of a window frame being provided for the window 20 as shown in FIGS. 1 and 2.

The present invention relates to a moving insect window screen among the above two types of the insect window screen, i.e. a sliding insect window screen or insect window screen in short. According to conventional configurations of the moving insect window screen, as shown by the accompanying drawings in FIG. 1, the roller of the lower screen chassis constituting the insect window screen 40 is firmly mounted on the lower rail provided on insect window installation frame 30 in the window frame, but a holder of the upper screen chassis constituting the window screen 40 is no longer in close contact with an upper rail provided on the insect window installation frame 30 of the window frame as shown in FIG. 2. Therefore, in a part of the upper rail, there is a problem such as noise generated in case of that the insect wind screen 40 is shaken by the wind.

In addition, for example, when a sliding insect window screen is additionally installed to a window system that is provided between the indoor living room the balcony, a special constructing structure of the sliding insect window screen is necessary for that the sliding insect window can be easily installed to the insect window installation frame and separated from the insect window installation frame according to the change of season. However, according to the prior art, in order to adapt the sliding insect window screen for easy installation and removal, there is a problem in that the insect window screen is jerking when it is sliding along the rail and is shaken by wind pressure because of large installation clearance.

In order to solve this problem, Korea Patent No. 10-0376971 B1 provided an additional guiding wing member made of soft and elastic synthetic resin to the holder of the upper chassis constituting the insect window screen. According to the additional guiding wing member, when sliding insect window screen is installed into the insect window installation frame of the window frame, the additional guiding wing member of the holder of the upper chassis is pushed into the upper rail of the insect window installation frame and therefore the additional guiding wing member is resiliently bended against the upper rail into a reinforcing rib. To the next, the roller of the upper chassis is placed on the lower rail of the insect window installation frame, and then the additional guiding wing member is resiliently recovered into the original form to firmly contact to the upper rail of the insect window installation frame. As a result of these upper and lower contact structure, shaking by wind pressure could be prevented.

However, the above-described structure including the resilient guiding wing member added to the holder of the upper chassis by the Korea Patent No. 10-0376971 B1 has a structural limitation with regard to the wind load proof because of its resilient properties and its short durability based upon soft material.

In addition, as described in the prior art with reference to the attached FIGS. 1 and 2 and the drawings of Korea Patent No. 10-0376971 B1, because that the upper rail and lower rail of the insect window installation frame is exposed, the chassis of the insect window screen may interferes with the visibility of the window. Accordingly, the value of the effort and cost required to remove the door chassis of the glass window for the wide visibility may be compromised by the chassis of the insect window screen.

### DETAILED DESCRIPTION OF THE INVENTION

### Technical Problem

The present invention has been made in order to solve the problems in the prior art and a technical object of the present invention is to provide a new sliding insect window installation structure being capable of improving constructing convenience as well as durability so as to ensure wind pressure proof.

In addition, the present invention is to provide a technical means for the insect window screen capable of being integrally installed within the insect window installation frame and being simply separated from the insect window installation frame, wherein this means is also capable of allowing that holder and/or roller of the insect window screen is firmly installed on the upper and/or lower rail without relying on resilient force of the additional elastic material.

Furthermore, this technical means for the insect window installation frame comprising the upper rail and lower rail is capable of minimizing the extent of outside exposure of the chassis of the insect window screen which may decrease the wide and good visibility through the glass window designed by removing the door chassis.

### Technical Solution

In order to solve the above-described problems, the present invention provides an insect window installation structure including an insect window installation frame for an insect window screen to be integrally installed within the insect window installation frame and to be simply separated from the insect window installation frame, comprising;

an insect window installation frame body pocket which is installed adjacent to a door installation frame; and

a rail bridge being detachably installed into an inside of said insect window installation frame body pocket with including rail extended along the sliding direction of the insect window screen at the position with a pre-determined distance from the bottom surface or ceiling surface of said insect window installation frame body pocket, and

wherein said rail bridge is formed as two or more rail bridge segments which are separately and detachably installed into the inside of said insect window installation frame body pocket, and

wherein said rail bridge segments are successively installed and detachably connected under or above the sliding insect window screen along the advancing direction of said rail.

### Advantageous Effects

According to the present invention, an insect window screen can be integrally installed within the insect window installation frame and the installed insect window screen also can be simply separated from the insect window installation frame. Moreover not only the lower chassis constituting the insect window screen but also upper chassis constituting the insect window screen can have a roller member which is more tightly installed into a narrow space so that very smooth sliding movement by the rollers can be achieved both of the upper and the lower rail on the insect window installation frame, and even if a strong wind blows against the sliding insect screen, it is possible for the sliding insect window screen to maintain a stable state without shaking movement.

Furthermore, an insect window installation structure according to the present invention, an effect of maximizing durability against the wind pressure with good airtight performance can be achieved.

In addition, the upper rail and lower rail of the insect window installation frame is less exposed, therefore the chassis of the insect window screen may not interferes with the visibility of the window.

### BRIEF DESCRIPTION OF THE DRAWINGS

FIGS. 1 and 2 are cross-sectional views illustrating a conventional sliding insect window installation structure.

FIG. 3 is a longitudinal cross-section view of illustrating a sliding insect window installation structure according to the present invention.

FIG. 4 is a plan view of illustrating a sliding window installation structure shown in FIG. 3.

FIGS. 5 to 7 are illustrating usefulness and applicability of a sliding window installation structure with regard to the sliding insect window installation structure according to the present invention.

FIGS. 8 to 10 are cross-sectional views illustrating the operating states of installation and removal of the sliding insect window screen by using the lower structure of the insect window installation structure according to the present invention.

FIGS. 11 to 13 are cross-sectional views illustrating the operating states of installation and removal of the sliding insect window screen by using the upper structure of the insect window installation structure according to the present invention.

FIGS. 14 to 19 are plan views illustrating the operating states of removal of the rail bridge and separation of the insect window screen in an embodiment comprising three rail bridge segments in the upper/lower structure.

FIG. 20 is a cross-sectional view illustrating the operating state of removal of pocket guide segment and sliding door from the door installation frame in the sliding window installation structure with regard to the insect window installation structure according to the present invention.

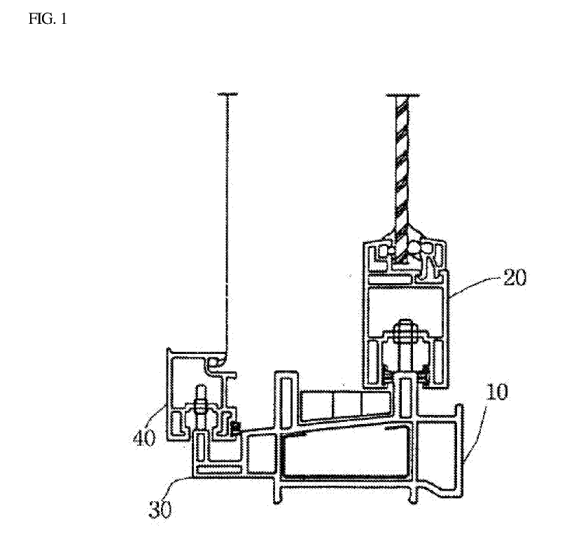

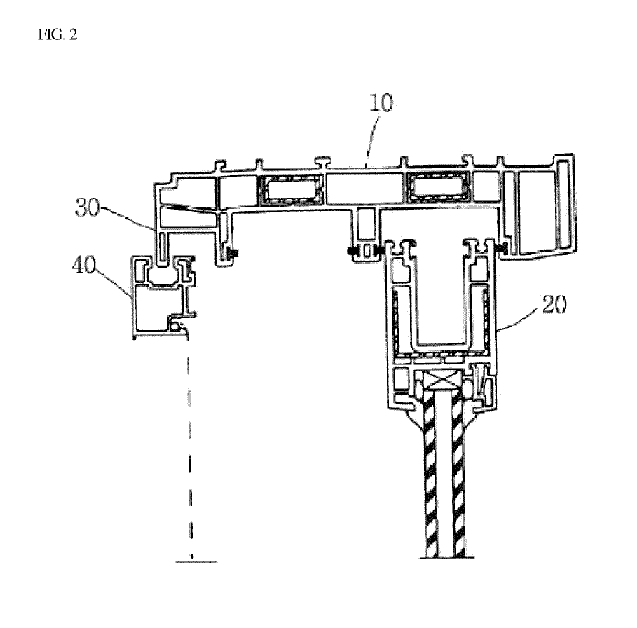

### MODE FOR CARRYING OUT THE INVENTION

Hereinafter, embodiments of the present invention will be described with reference to the accompanying drawings such that a person ordinarily skilled in the art to which the present invention belongs may easily embody the present invention. However, the present invention may be implemented in various forms and is not limited to the embodiments described hereinafter.

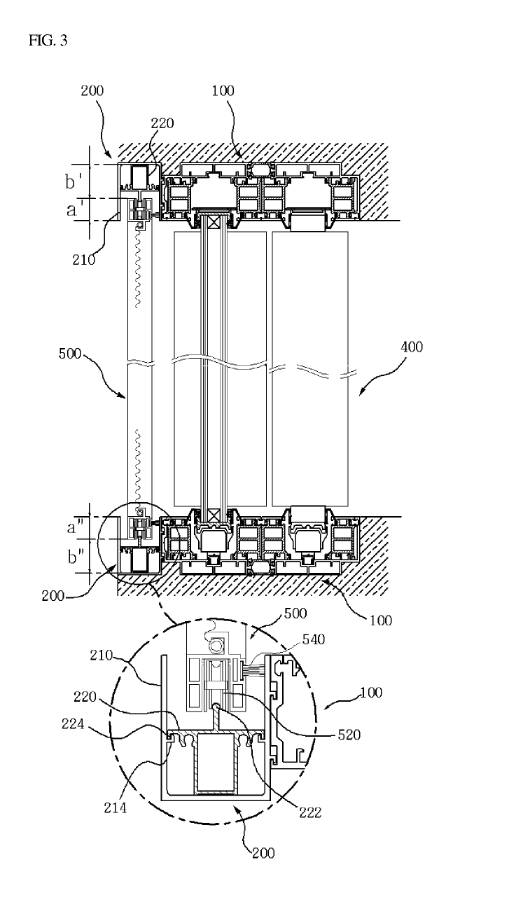

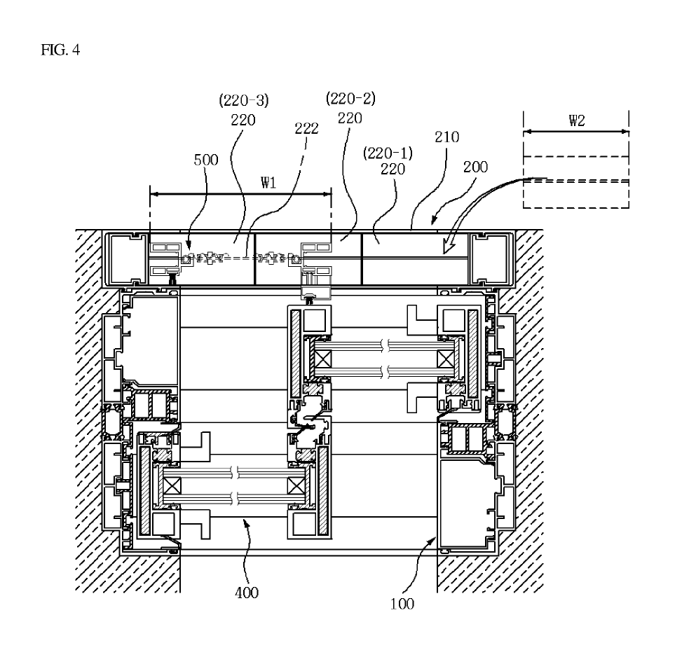

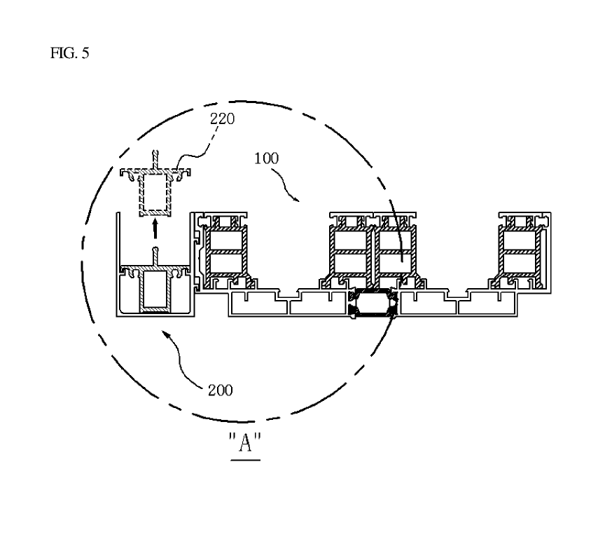

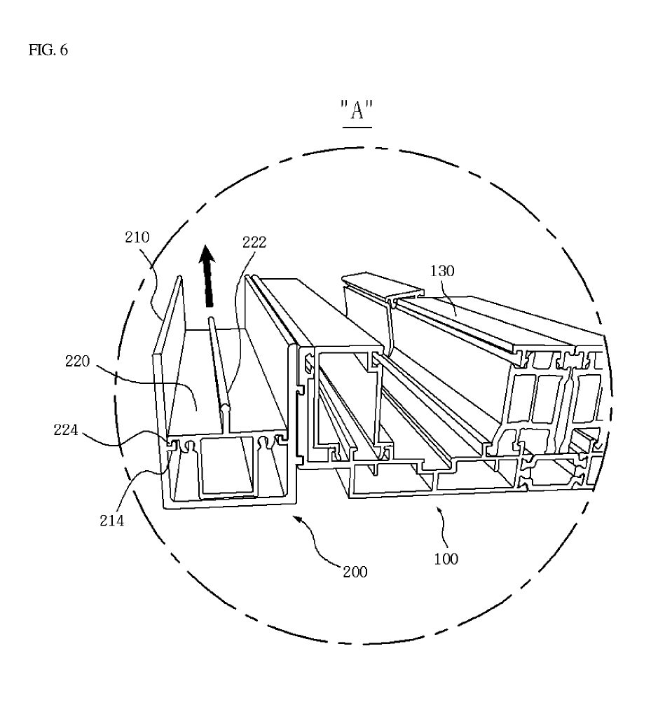

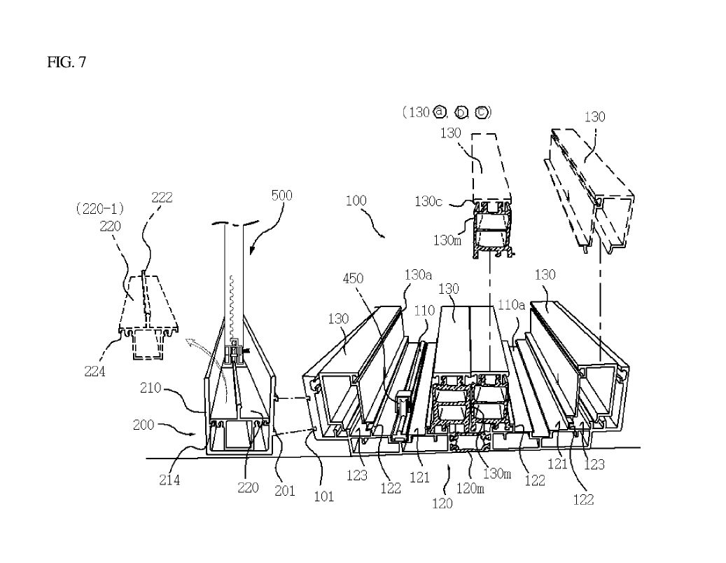

As described previously, the present invention is intended to solve a problem for the improvement of the sliding insect window installation structure for the insect window screen not to be an obstacle in case of being used together with the special window system having the increased openness of the windows, and also is intended to solve a structural problem produced in case of the installation or separation of the sliding insect screen. Herein, FIG. 3 is a longitudinal cross-section view of illustrating a sliding insect window installation structure according to the present invention, FIG. 4 is a plan view of illustrating a sliding window installation structure shown in FIG. 3, and FIGS. 5 to 7 are illustrating usefulness and applicability of a sliding window installation structure with regard to the sliding insect window installation structure according to the present invention.

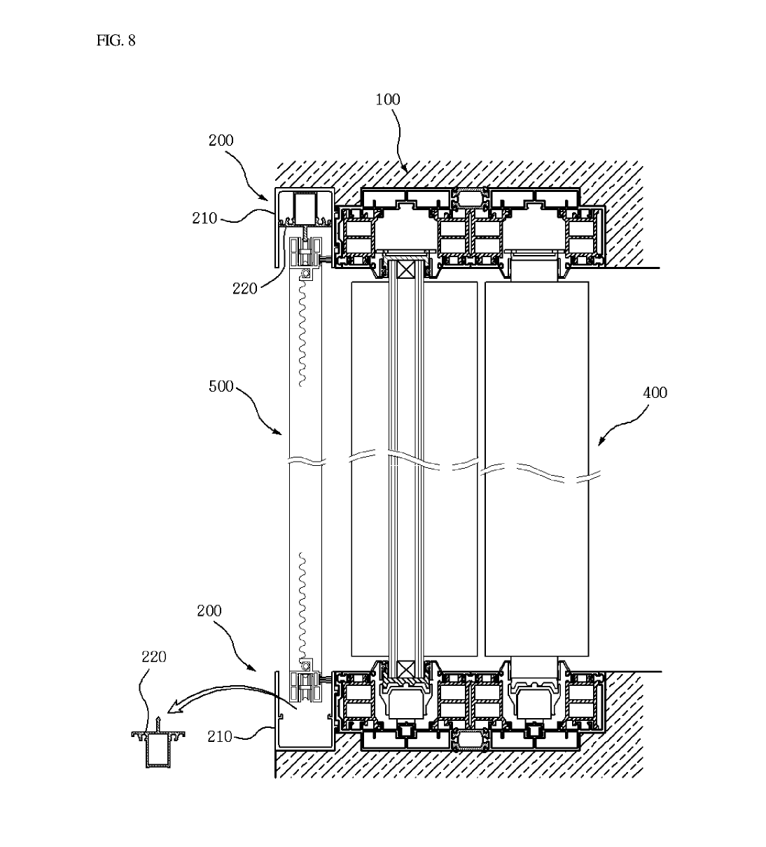

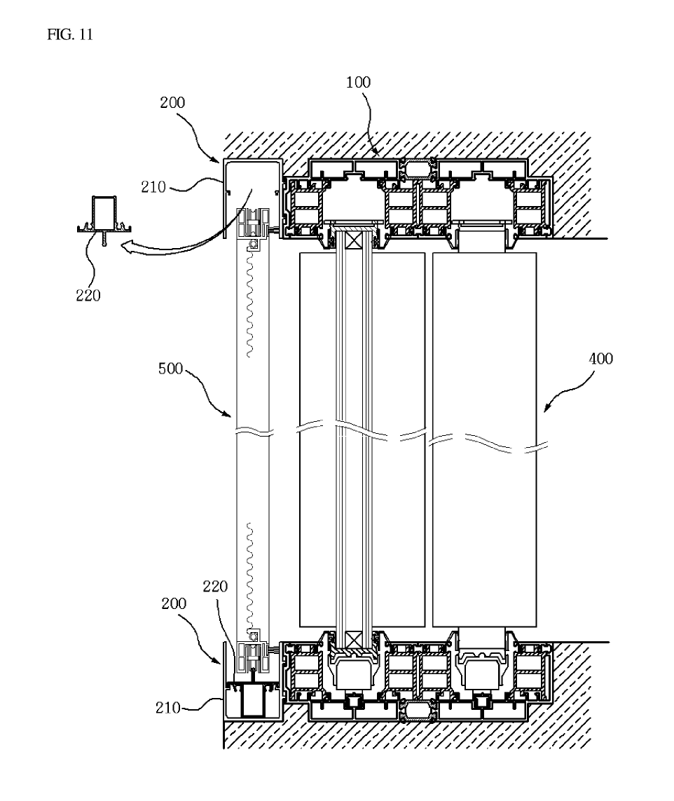

In addition, FIGS. 8 to 10 are cross-sectional views illustrating the operating states of installation and removal of the sliding insect window screen in case of using the lower structure of the insect window installation structure according to the present invention, and FIGS. 11 to 13 are cross-sectional views illustrating the operating states of installation and removal of the sliding insect window screen in case of using the upper structure of the insect window installation structure according to the present invention.

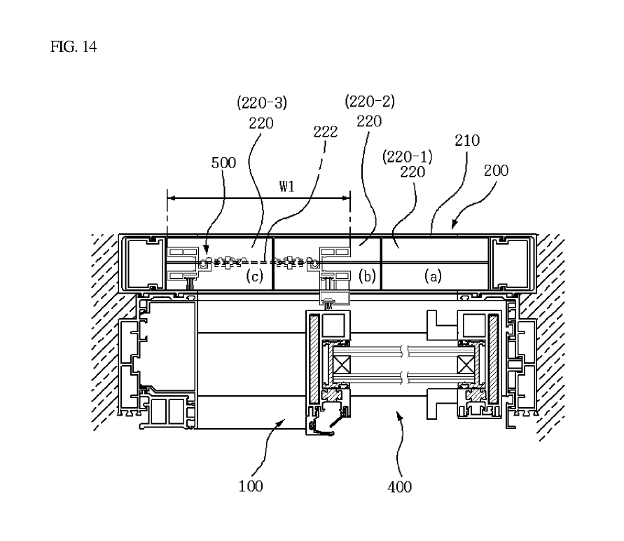

Moreover, FIGS. 14 to 19 are plan views illustrating the operating states of removal of the rail bridge and separation of the insect window screen in an embodiment comprising three rail bridge segments in the upper or lower structure.

An embodiment of the present invention exemplified in the drawings provides an insect window installation frame 200, for an insect window screen 500 to be integrally installed within the insect window installation frame 200 and to be simply separated from the insect window installation frame 200, comprising;

an insect window installation frame body pocket 210 which is installed adjacent to a door installation frame 100; and

a rail bridge 220 being detachably installed into an inside of said insect window installation frame body pocket 210 with including rail 222 extended along the sliding direction of the insect window screen 500 at the position with a pre-determined distance from the bottom surface or ceiling surface of said insect window installation frame body pocket 210.

Whereas, a locking projection 201 may be protruded outside of one side of said insect window installation frame body pocket 210, and said locking projection 201 can be inserted and coupled into a fastening groove 101 formed on the concave outer side of the door installation frame 100.

In addition, said rail bridge 220 is formed as two or more rail bridge segments 220-1, 220-2, 220-3 which are separately and detachably installed into the inside of said insect window installation frame body pocket 210, and said rail bridge segments 220-1, 220-2, 220-3 are successively installed and detachably connected under or above the sliding insect window screen 500 along the advancing direction of said rail 222.

Preferably, so that said rail bridge 220 having a segmented structure which are separately and detachably installed, i.e. two or more rail bridge segments 220-1, 220-2, 220-3 can be installed into the inside of said insect window installation frame body pocket 210, as shown in FIGS. 3 to 7, a fastening tab 214 is provided along the advancing direction of said rail 222 in the inner side of said insect window installation frame body pocket 210, and a inserting projection 224 is provided along the advancing direction of said rail 222 on the inner/outer end of said rail bridge 220 so that said inserting projection 224 can be inserted into said fastening tab 214. Therefore, based upon the friction generated between said inserting projection 224 and said fastening tab 214, said rail bridge 220 could not be separated from said insect window installation frame body pocket 210 without applying the external force. However, it is preferred that said inserting projection 224 and said fastening tab 214 are formed so that said rail bridge 220 could be easily detached from said insect window installation frame body pocket 210 when a user grips and pulls said rail 222 extruded from an upper surface of the bridge rail 220.

Further, said rail bridge segment 220: 220-1, 220-2, or 220-3 being provided as a bridge rail 220, can be provided into any one or more structure among the upper structure and the lower structure of said insect window installation frame 200, and as illustrated in the accompanying drawings, the sliding insect window screen 500 have a diversity in the working direction of installation and removal (the sliding insect window screen 500 may be installed/removed in various directions) in case of being provided all of the upper structure and the lower structure of said insect window installation frame 200.

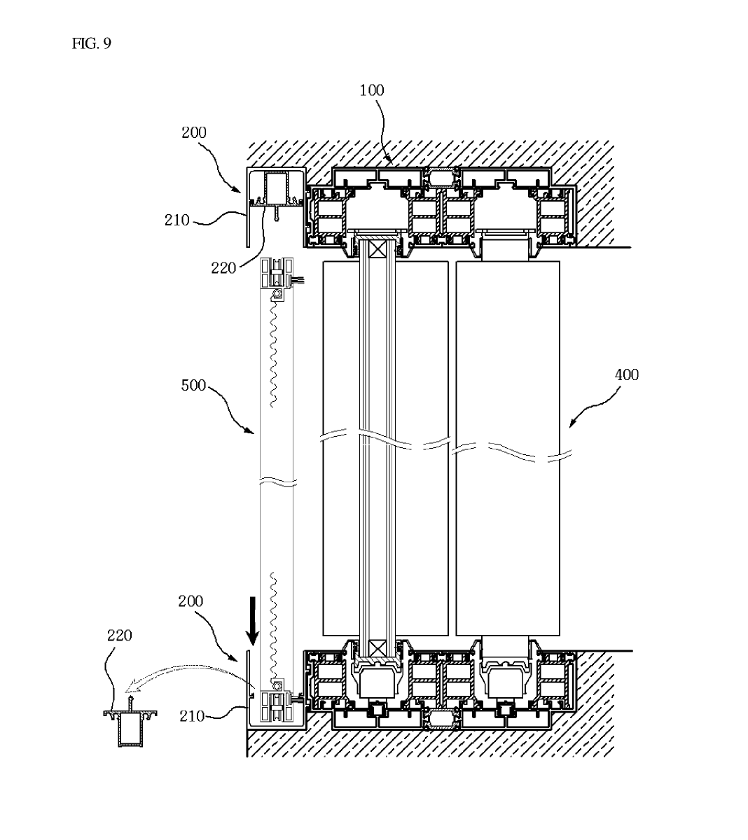

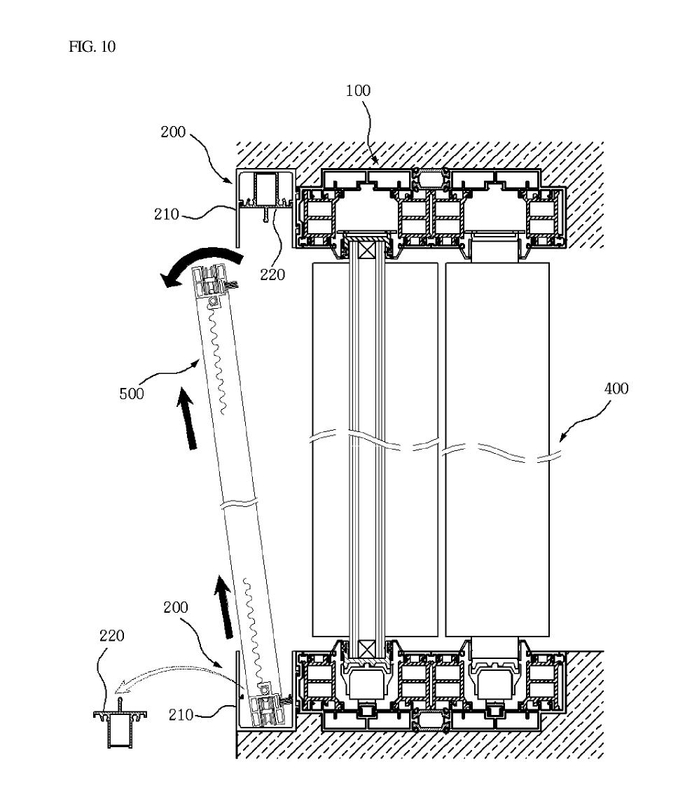

Herein, when said rail bridge 220 are removed from one of the upper structure and the lower structure of said insect window installation frame 200 as illustrated in FIG. 3, in order that the sliding insect window screen 500 can be easily separated from the inner surface of said insect window installation frame body pocket 210 of said insect window installation frame 200, for example, if a distance (refer to b″ of FIG. 3) from the lower end of the sliding insect window screen 500 to the bottom surface of the lower structure of said insect window installation frame body pocket 210 is greater than a distance (refer to a′ of FIG. 3) from the upper end of the sliding insect window screen 500 to the lower end of the upper structure of said insect window installation frame body pocket 210, said rail bridge 220 is detached from said insect window installation frame body pocket 210 provided in the lower structure of said insect window installation frame 200 (see FIG. 8), and then the sliding insect window screen 500 can be downwardly moved into the free space (see FIG. 9), and then, as the upper end of said insect window screen 500 can be rotated in the forward outside the lower end of said insect window installation frame body pocket 210 of the upper structure (see FIG. 10). Finally, if said insect window screen 500 is slant upwardly lifted in this state, said insect window screen 500 can be removed from said insect window installation frame body pocket 210 of the lower structure (see FIGS. 8 to 10).

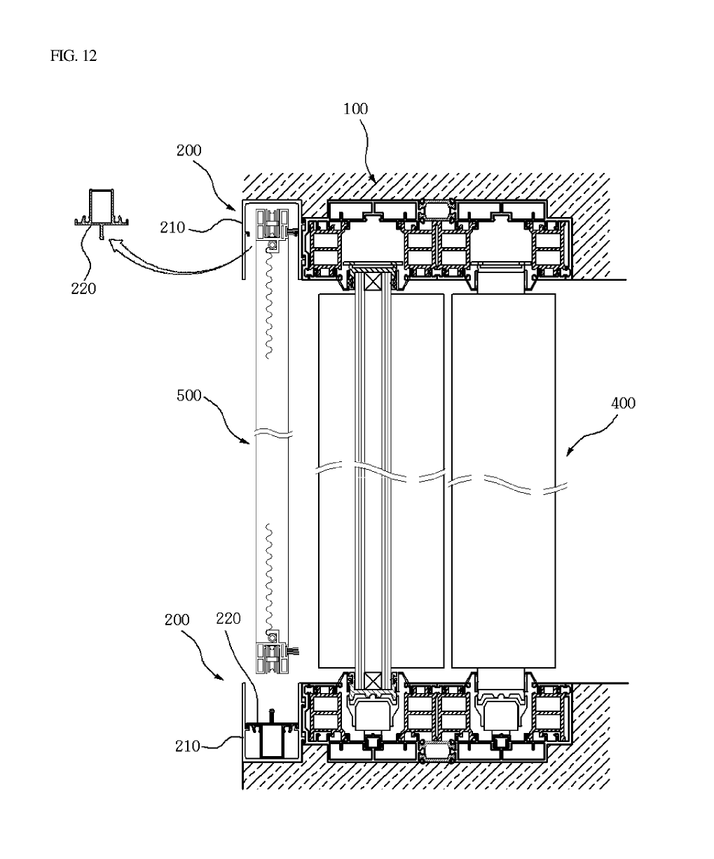

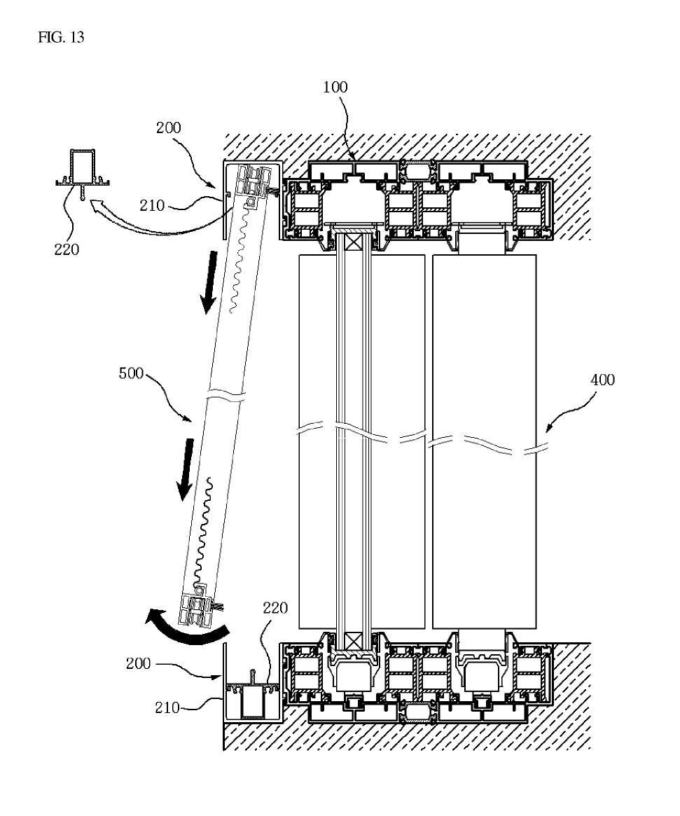

On the contrary case, said rail bridge 220 is firstly detached from said insect window installation frame body pocket 210 provided in the upper structure of said insect window installation frame 200 (see FIG. 11), and then the sliding insect window screen 500 can be upwardly moved into the free space (see FIG. 12), and then, as the lower end of said insect window screen 500 can be rotated in the forward outside the upper end of said insect window installation frame body pocket 210 of the lower structure (see FIG. 13), and finally if said insect window screen 500 is slant downwardly moved in this state, said insect window screen 500 can be removed from said insect window installation frame body pocket 210 of the upper structure (see FIGS. 11 to 13). Meanwhile, in order that such removal can be easily achieved, a distance (refer to b′ of FIG. 3) from the upper end of the sliding insect window screen 500 to the upper end of the upper structure of said insect window installation frame body pocket 210 should be greater than a distance (refer to a″ of FIG. 3) from the lower end of the sliding insect window screen 500 to the upper end of the lower structure of said insect window installation frame body pocket 210.

Thus, according to the insect window installation structure including the insect window installation frame having a segmented structure which is separately and detachably installed, as shown by the FIGS. 8 to 10 and FIGS. 11 to 13, if said rail bridge segment 220: 220-1, 220-2, or 220-3 being provided as the rail bridge 220 at any one of the upper structure and the lower structure of said insect window installation frame 200 is removed from the said insect window installation frame 200, said insect window screen 500 also can be removed from said insect window installation frame body pocket 210, and the insect window screen 500 assembled through the production line can be integrally installed into said insect window installation frame body pocket 210. Furthermore, an insect window installation structure capable of maximizing durability against the wind pressure with good airtight performance can be achieved because that a chassis portion of the insect window screen 500 is substantially accommodated in said insect window installation frame 200 as shown in the figures.

In addition, in order to improve dust resistance, water-tightness, and air-tightness of the sliding insect window screen system having the above-described structure, as illustrated in FIG. 3, blocking members 540 such as mohair may be installed in a horizontal longitudinal direction on the opposite surfaces of said rail bridge segment 220: 220-1, 220-2, or 220-3 provided as the rail bridge 220 and said sliding insect window screen 500.

Meanwhile, in the case of the sliding insect window screen systems according to the embodiments described above, descriptions will be made on the configuration which allows the rail bridge segments 220: 220-1, 220-2, 220-3 provided as the rail bridge 220 to be easily separated from said insect window installation frame body pocket 210 of the insect window installation frame 200 without interference with said sliding insect window screen 500 (refer to FIGS. 8 and 11) and the operating procedure thereof.

Hereinafter, embodiments of the apparatus for this removal process will be described with reference to the accompanying drawings such that a person ordinarily skilled in the art to which the present invention belongs may easily embody the present invention.

First, as illustrated in FIG. 4, said rail bridge segments 220: 220-1, 220-2, 220-3 provided as the rail bridge 220 in the upper or lower structure of the sliding window screen 500 are divisionally formed as two or more segments over the entire length of the rail 222 (FIG. 4 being an illustrative three segments), and one or more segments may be formed to have a length removable from said insect window installation frame body pocket 210 in a state where the sliding insect window screen 500 is installed to be seated on the rollers 520 on the rail 222 of the other segment on the rail bridge 220.

Hereinafter, the operation of the present invention will be described with reference to FIGS. 14 to 19, assuming that three rail bridge segments 220-1, 220-2, 220-3 are divisionally installed as the rail bridge 220 in the upper structure or the lower structure of the sliding insect window screen 500 along the entire length of the rail 222, as an example.

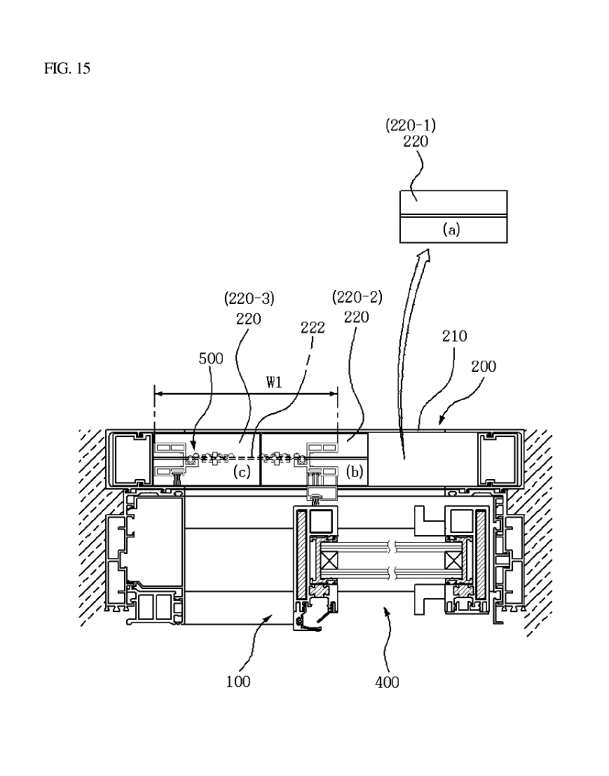

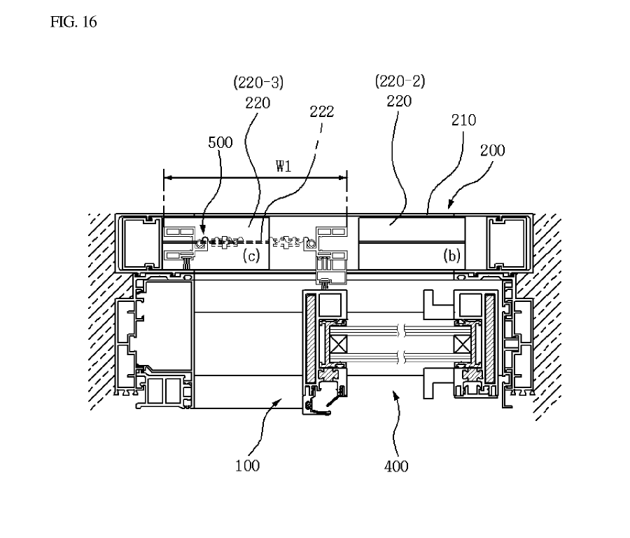

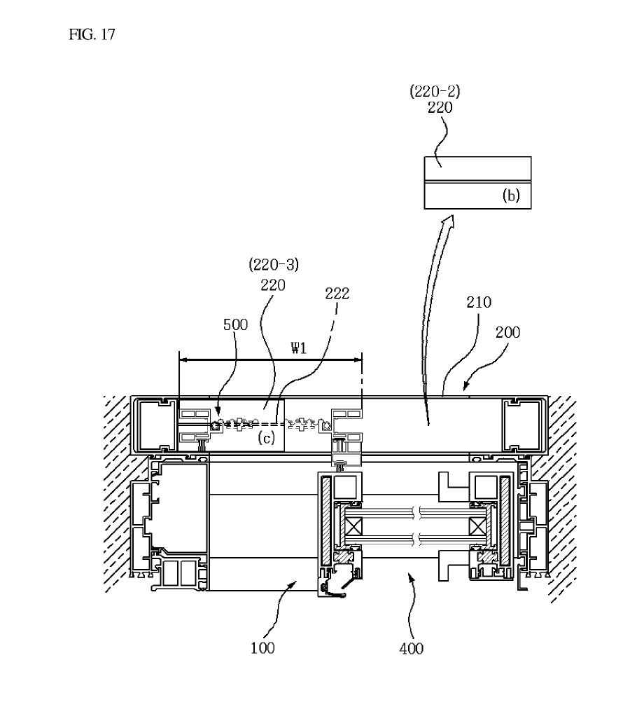

First, when the sliding insect window screen 500 is in the closed state as illustrated in FIG. 14, sliding insect window screen 500 is in the state where it cannot be easily removed from the insect window installation frame boy pocket 210 of the insect window installation frame 200 due to the interference between the rail bridge segments 220-2, 220-3 (segments noted by (b) and (c) in FIG. 14) provided as the rail bridge 220 and the sliding insect window screen 500. However, the rail bridge segments 220-3 (segments noted by (a) in FIG. 14) located at a position where the sliding insect window screen 500 is not positioned as illustrated in FIG. 15 may be removed from the insect window installation frame body pocket 210 of the insect window installation frame 200. Then, when the rail bridge segments 220-2 is slid into the position of the removed the rail bridge segments 220-1 as illustrated in FIG. 16, so that the rail bridge segments 220-2 also can be removed from the insect window installation frame body pocket 210 of the insect window installation frame 200, as illustrated in FIG. 17.

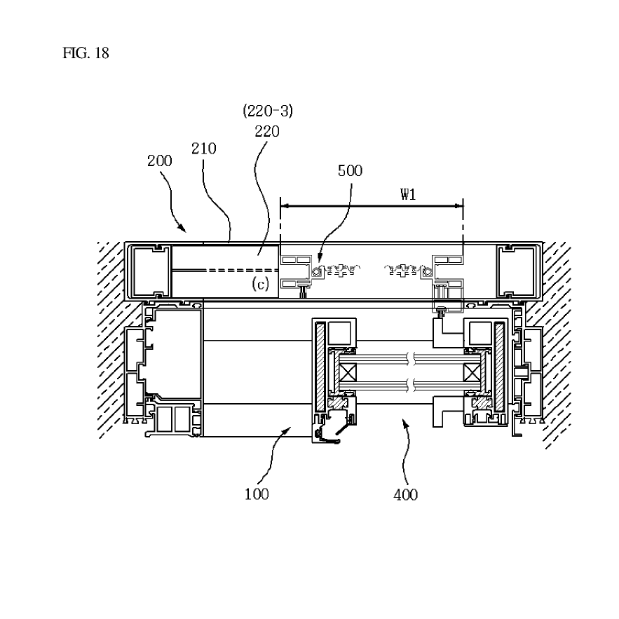

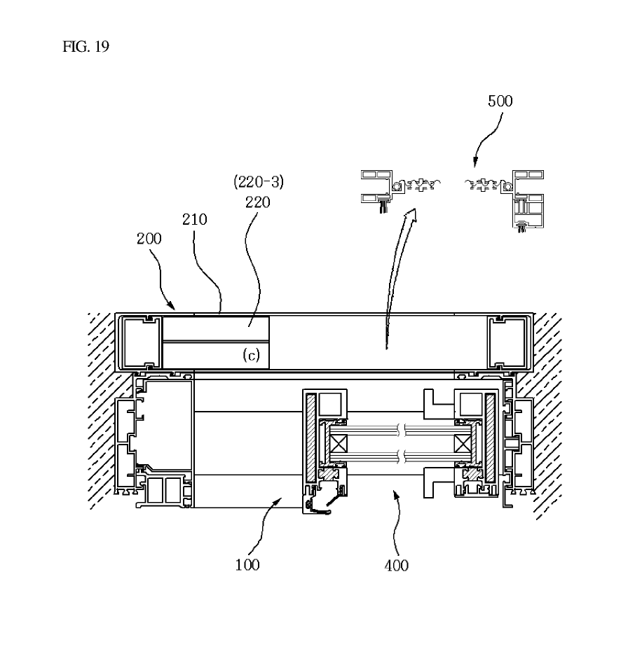

In the state illustrated in FIG. 18 in which two rail bridge segments 220-1 and 220-2 are removed from the insect window installation frame body pocket 210 of the insect window installation frame 200, the sliding insect window screen 500 may be removed from the insect window installation frame body pocket 210 of the insect window installation frame 200 as described above with reference to FIGS. 8 to 10 and 11 to 13. The state in which the sliding insect window screen 500 is removed is illustrated in FIG. 19.

Meanwhile, the order performed from FIGS. 14 to 19 may be referred to as the steps of removing the sliding insect window screen 500 from the insect window installation frame body pocket 210 of the insect window installation frame 200 and on the contrary, the order performed from FIG. 19 to FIG. 14 may be referred to as the steps of installing the sliding insect window screen 500 into the insect window installation frame body pocket 210 of the insect window installation frame 200.

The embodiment described above exemplifies a case in which three rail bridge segments 220-1, 220-2, 220-3 are divisionally installed as the rail bridge 220 along the entire length of the rail 222 in the upper or lower structure of the sliding insect window screen 500. Unlike this, it can be seen that the present invention may be implemented by divisionally installing the rail bridge segments 220-1, 220-2 having different lengths as the rail bridge 220. That is, in this case, the rail bridge segment larger than the entire width of the sliding insect window screen 500 may be removed from the insect window installation frame 200 so that the sliding insect window screen 500 may be removed from the insect window installation frame 200 or installed into the insect window installation frame 200 without any difficulty.

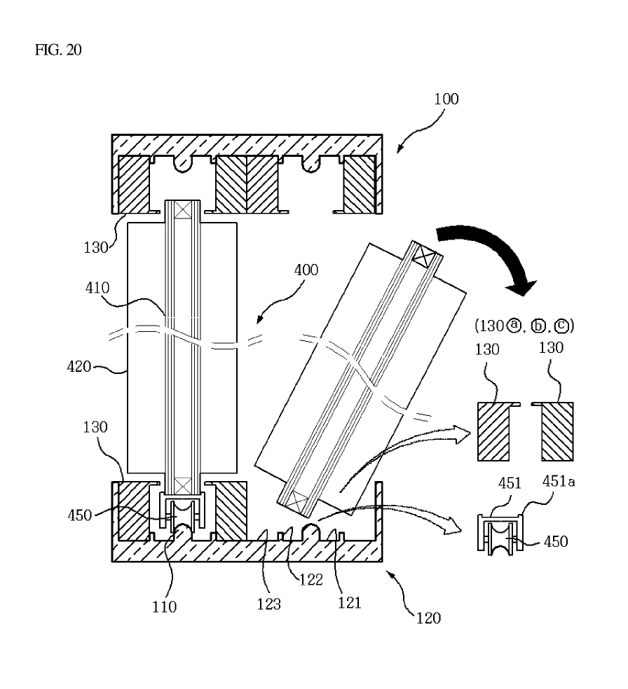

In addition, according to the concept similar to the present invention, the pocket guide segments 130: 130\textcircled{a}, 130\textcircled{b}, or 130\textcircled{c} provided as the pocket guide 130 supporting sliding window 400 may be provided in an upper structure and/or a lower structure of the door guide frame 100, and therefore the sliding window 400 can be removed or installed in the door guide frame 100 (refer to FIG. 20). The more detailed descriptions with regard to the entire constitution and operation for this invention, are described in the Korea Patent Application No. 102012-0047789 and the PCT application No. PCT/KR2013/003912 previously filed by inventor and applicant of the present invention, therefore the specification and drawings filed incorporated by reference.

The scope of the present invention to be protected is not limited thereto and may cover various types of insect windows to which the present invention is applied, and various modifications and changes using the basic concept of the present invention defined in the accompanying claims also belong to the scope of the present invention.

1. An insect window installation frame, for an insect window screen to be integrally installed within the insect window installation frame and to be simply separated from the insect window installation frame, comprising;
an insect window installation frame body pocket which is installed adjacent to a door installation frame; and
a rail bridge being detachably installed into an inside of said insect window installation frame body pocket with including rail extended along the sliding direction of the insect window screen at the position with a pre-determined distance from the bottom surface or ceiling surface of said insect window installation frame body pocket, and
wherein said rail bridge is formed as two or more rail bridge segments which are separately and detachably installed into the inside of said insect window installation frame body pocket, and
wherein said rail bridge segments are successively installed and detachably connected under or above the sliding insect window screen along the advancing direction of said rail.

2. The insect window installation frame of claim 1, wherein said rail bridge segment being provided as a bridge rail, is provided into any one or more structure among the upper structure and the lower structure of said insect window installation frame.

3. The insect window installation frame of claim 2, wherein said rail bridge segments provided as the rail bridge are divisionally formed as two or more segments over the entire length of the rail, and one or more segments may be formed to have a length removable from said insect window installation frame body pocket in a state where the sliding insect window screen is installed to be seated on the rail of the other segment.

4. The insect window installation frame of claim 3, wherein, in order to improve dust resistance, water-tightness, and air-tightness of the sliding insect window screen system, blocking members are installed in a horizontal longitudinal direction on the opposite surfaces of said rail bridge segment provided as the rail bridge and said sliding insect window screen.

5. The insect window installation frame of claim 3, wherein, so that said rail bridge can be separately and detachably installed into the inside of said insect window installation frame body pocket, a fastening tab is provided along the advancing direction of said rail in the inner side of said insect window installation frame body pocket, and a inserting projection is provided along the advancing direction of said rail on the inner/outer end of said rail bridge so that said inserting projection can be inserted into said fastening tab.
